(19) United States
(12) Patent Application Publication
(10) Pub. No.: US 2013/0151245 A1
(43) Pub. Date: Jun. 13, 2013

(54) Method for Determining Fundamental-Frequency Courses of a Plurality of Signal Sources

(71) Applicants: Michael Stark, Graz (AT); Michael Wohlmayr, Graz (AT); Franz Pernkopf, Graz (AT)

(72) Inventors: Michael Stark, Graz (AT); Michael Wohlmayr, Graz (AT); Franz Pernkopf, Graz (AT)

(73) Assignee: TECHNISCHE UNIVERSITAT GRAZ, Graz (AT)

(21) Appl. No.: 13/582,057

(22) PCT Filed: Feb. 22, 2011
(86) PCT No.: PCT/AT2011/000088

§ 371 Date: Oct. 15, 2012

(30) Foreign Application Priority Data
Mar. 1, 2010 (AT) A 315/2010

(51) Int. Cl. G10L 25/90

(52) U.S. Cl. CPC G10L 25/90
USPC 704/207

(57) ABSTRACT

The invention relates to a method for establishing fundamental frequency curves of a plurality of signal sources from a single-channel audio recording of a mix signal, said method including the following steps:

a) establishing the spectrogram properties of the pitch states of individual signal sources with use of training data;

b) establishing the probabilities of the fundamental frequency combinations of the signal sources contained in the mix signal by a combination of the properties established in a) by means of an interaction model; and

c) tracking the fundamental frequency curves of the individual signal sources.

The invention relates to a method for establishing fundamental frequency curves of a plurality of signal sources from a single-channel audio recording of a mix signal.

Methods for tracking or separating single-channel speech signals over the perceived fundamental frequency (the technical term “pitch” will be used synonymously with “perceived fundamental frequency” within the scope of the following embodiments) are used in a range of algorithms and applications in speech signal processing and audio signal processing, such as in single-channel blind source separation (SCSS) (D. Morgan et al., “Cochannel speaker separation by harmonic enhancement and suppression”, IEEE Transactions on Speech and Audio Processing, vol. 5, p. 407-424, 1997), computational auditory scene analysis (CASA) (DeLiang Wang, “On Ideal Binary Mask As the Computational Goal of Auditory Scene Analysis”, P. Divenyi [Ed], Speech Separation by Humans and Machines, Kluwer Academic, 2004) and speech compression (R. Salami et al., “A toll quality 8 kb/ s speech codec for the personal communications system (PCS)”, IEEE Transactions on Vehicular Technology, vol. 43, p. 808-816, 1994). Typical applications of such methods include conferences for example, where several voices may sometimes be audible during a presentation and the recognition rate of automatic speech recognition thus reduces considerably. An application in hearing devices is also possible.

Fundamental frequency is a fundamental parameter in the analysis, recognition, coding, compression and reproduction of speech. Speech signals can be described by the superposition of sinusoidal vibrations. For voiced sounds, such as vocals, the frequency of these vibrations is either the fundamental frequency or a multiple of the fundamental frequency (what are known as “harmonics” or “overtones”). Speech signals can therefore be assigned to specific signal sources by identifying the fundamental frequency of the signal.

Although, in the case of an individual speaker with low-noise recording, a range of tried and tested methods for estimating or tracking the fundamental frequency are already in use, problems are still encountered when processing inferior recordings (that is to say recordings containing disturbance such as rustling) of a number of people speaking at the same time.

In “A Multipitch Tracking Algorithm for Noisy Speech” (IEEE Transactions on Speech and Audio Processing, Volume 11, Issue 3, p. 229-241, May 2003), Mingyang Wu et al. propose a solution for robust, multiple fundamental frequency tracking in recordings with a number of speakers. The solution is based on the unitary model for fundamental frequency perception, for which different improvements are proposed so as to obtain a probabilistic reproduction of the periodicities of the signal. The tracking of the probabilities of the periodicities with use of the hidden Markov model (HMM) makes it possible to reproduce semi-continuous fundamental frequency curves. Disadvantages of this solution include the high processing effort and the resultant necessary processor sources on the one hand, and on the other hand the fact that correct assignment of the fundamental frequencies to the matching signal sources or speakers is not possible. The reason for this is the fact that, in this system, no speaker-specific information, which would allow such linking of measured pitch values and speakers, is incorporated or available.

The object of the invention is therefore to provide a method for multiple fundamental frequency tracking, said method allowing reliable assignment of the established fundamental frequencies to signal sources or speakers and, at the same time, having low storage and processor intensity.

In accordance with the invention, this object is achieved with a method of the type described in the introduction by the following steps:
a) establishing the spectrogram properties of the pitch states of individual signal sources with use of training data;
b) establishing the probabilities of the possible fundamental frequency combinations of the signal sources contained in the mix signal by a combination of the properties established in a) by means of an interaction model;
c) tracking the fundamental frequency curves of the individual signal sources.

Thanks to the invention, a high level of accuracy of the tracking of the multiple fundamental frequencies can be achieved, and fundamental frequency curves can be better assigned to the respective signal sources or speakers. As a result of a training phase a) with use of speaker-specific information and the selection of a suitable interaction model in b), the processing effort is minimised considerably, and therefore the method can be carried out quickly and with few resources. In this case, mixed spectra containing the respective individual speaker portions (in the simplest case two speakers and a corresponding fundamental frequency pair) are not trained, but instead the respective individual speaker portions, which further minimises the processing effort and the number of training phases to be carried out. Since pitch states from a defined frequency range (for example 80 to 500 Hz) are considered per signal source, a limited number of fundamental frequency combinations, which can be referred to as “possible” fundamental frequency combinations, are produced when combining the states in step b). The term “spectrum” will be used hereinafter to refer to the magnitude spectrum; depending on the choice of the interaction model in b), the short-term magnitude spectrum or the logarithmic short-term magnitude spectrum (log spectrum) are used.

The number of pitch states to be trained is provided from the observed frequency range and the division thereof (see further below). In the case of speech recordings, such a frequency range is 80 to 500 Hz for example.

A probability model of all pitch combinations possible in the above-mentioned frequency range or for a desired speaker pair (that is to say for a recording in which two speakers can be heard for example) can be obtained from speech models of individual speakers with the aid of the interaction model applied in b). When recording two speakers with A states in each case, this therefore means that an A×A matrix with the probabilities for all possible combinations is established. Speech models describing a large number of speakers can also be used for the individual speakers, for example since the model is geared to gender-specific features (speaker-independent, or gender-dependent).

A range of algorithms can be used for the tracking in c). For example, the temporal sequence of the estimated pitch values can be modelled by a hidden Markov model (HMM) or by a factorial hidden Markov model (FHMM), and the max-sum algorithm, the junction-tree algorithm or the sum-product algorithm can be used in these graphic models. In one variant of the invention, it is also possible to consider and evaluate the pitch values estimated over isolated time windows independently of one another, without applying one of the above-mentioned tracking algorithms.

A general, parametric or non-parametric statistical model can be used to describe the spectrogram properties. In a), the spectrogram properties are advantageously established by means of a Gaussian mixture model (GMM).

The number of components of a GMM is advantageously established by applying the minimum-description-length (MDL) criterion. The MDL criterion is used for selection of a model from a multiplicity of possible models. For example, the models differ, as in the present case, merely by the number of Gaussian components used. In addition to the MDL criterion, the use of the Akaike information criterion (AIC) is also possible, for example.

In b), a linear model or the mixture-maximisation (mix-max) interaction model or the ALGONQUIN interaction model is used as the interaction model.

The tracking in c) is advantageously carried out by means of the factorial hidden Markov model (FHMM).

A range of algorithms can be used to carry out tracking on a FHMM, for example the sum-product algorithm or the max-sum algorithm are used in variants of the invention.

The invention will be explained in greater detail hereinafter on the basis of a non-limiting exemplary embodiment, which is illustrated in the drawing, in which:

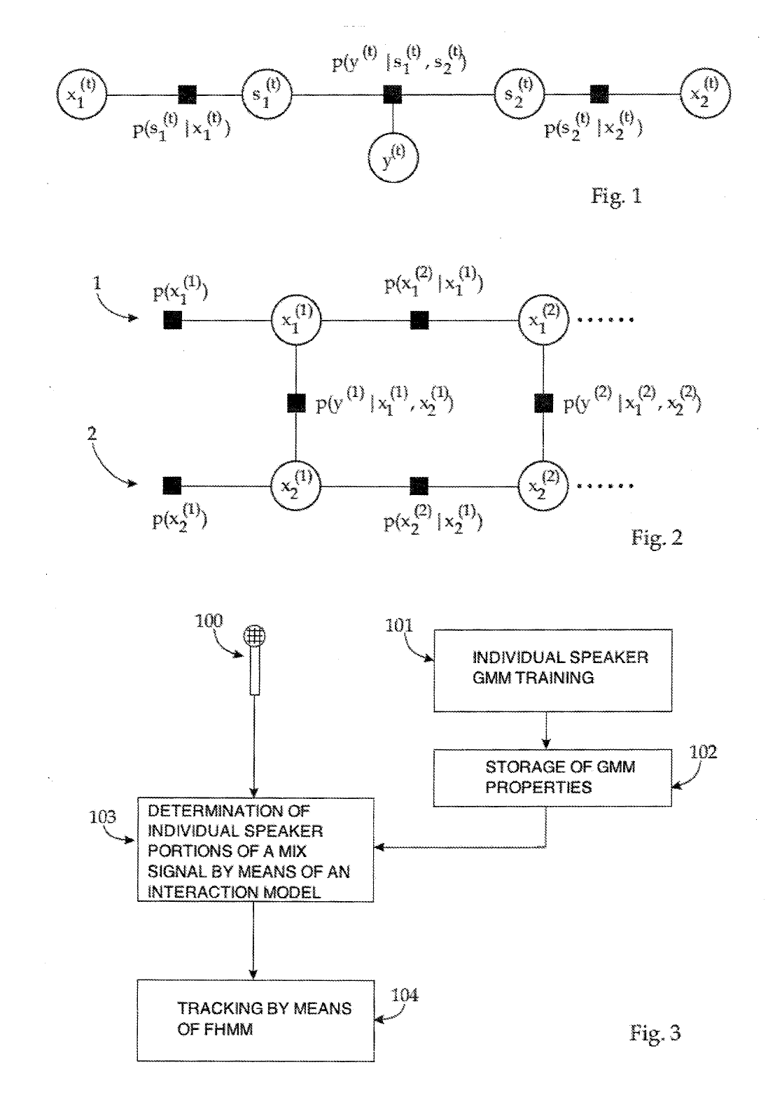

FIG. 1 shows a schematic view of a factor graph of the fundamental-frequency-dependent generation of a (log) spectrum y of a mix signal resulting from two individual speaker (log) spectra,

FIG. 2 shows a schematic illustration of the FHMM, and

FIG. 3 shows a schematic view of a block diagram of the method according to the invention.

The invention relates to a simple and efficient modelling method for fundamental frequency tracking of a plurality of signal sources emitting simultaneously, for example speakers in a conference or meeting. For reasons of clarity, the method according to the invention will be presented hereinafter on the basis of two speakers, although the method can be applied to any number of subjects. The speech signals are single-channel in this case, that is to say they are recorded by just one recording means, for example a microphone.

The short-term spectrum of a speech signal at a given fundamental frequency of speech can be described with the aid of probability distributions, such as the Gaussian normal distribution. An individual normal distribution, given by the parameters of mean value μ and variance σ², is generally not sufficient. Mixed distributions, such as the Gaussian mixture model (or GMM), are normally used to model general, complex probability distributions. The GMM is composed cumulatively from a number of individual Gaussian normal distributions. An M-times Gaussian distribution with 3M-1 parameters can be described—mean value, variance and weighting factor, for each of the M Gaussian distributions (the weighting factor of the Mth Gaussian component is redundant, and therefore “−1”). A special case of the “expectation maximisation” algorithm is often used for the modelling of observed data points by a GMM, as is described further below.

The curve of the pitch states of a speaker can be described approximately by a Markov chain. The Markov property of this state chain indicates that the successor state is only dependent on the current state and not on previous states.

When analysing a speech signal of two subjects speaking simultaneously, only the resultant spectrum y^{(t)} of the mixture of the two individual speech signals is available, but not the pitch states x₁^{(t)} and x₂^{(t)} of the individual speakers. The subscript index in the pitch states denotes speakers 1 and 2 in this case, whilst the superscript time index runs from t=1, . . . , T. These individual pitch states are hidden variables. For example, a hidden Markov model (HMM), in which the hidden variables or states can be established from the observed states (therefore in this case from the resultant spectrum y^{(t)} of the mixture), is used for assessment.

In the exemplary embodiment described, each hidden variable has |X|=170 states with fundamental frequencies from the interval of 80 to 500 Hz. Of course, more or fewer states from other fundamental frequency intervals can also be used.

The state “1” means “no pitch” (voiceless or no speech activity), whilst state values “2” to “170” denote different fundamental frequencies between the above-mentioned values. More specifically, the pitch value f₀ for the states x>1 is established by the formula

$${f}_{0} = \frac{{f}_{s}}{30 + x} .$$

The sampling rate is f_{S}=16 kHz. The pitch interval is therefore of varying resolution; low pitch values have a finer resolution compared to high pitch values: The states 168, 169 and 170 have fundamental frequencies of 80.80 Hz (x=168), 80.40 Hz (x=169) and 80.00 Hz (x=170), whilst the states 2, 3 and 4 have the fundamental frequencies 500.00 Hz (x=2), 484.84 Hz (x=3) and 470.58 Hz.

The method according to the invention comprises the following steps in the described exemplary embodiment:
Training phase: training a speaker-dependent GMM for modelling the short-term spectrum for each of the 170 states (169 fundamental frequency states and the “no pitch” state) of each individual speaker;
Interaction model: establishing a probabilistic representation for the mixture of the two individual speakers with use of an interaction model, for example the mix-max interaction model; either the short-term magnitude spectrum or the logarithmic short-term magnitude spectrum is modelled in the training phase depending on the selection of the interaction model.
Tracking: establishing the fundamental frequency trajectories of the two individual speakers with use of a suitable tracking algorithm, for example junction-tree or sum-product (in the present exemplary embodiment the use of the factorial hidden Markov model (FHMM) is described).

### Training Phase

In the method according to the invention a monitored scenario is assumed, in which the speech signals of the individual speakers are modelled with use of training data. In principle, all monitored training methods can be used, that is to say generative and discriminative methods. The spectrogram properties can be described by a general, parametric or non-parametric, statistical model p(sᵢ|xᵢ). The use of GMMs is thus a special case.

In the present exemplary embodiment 170 GMMs are trained with use of the EM (expectation maximisation) algorithm for each speaker (one GMM per pitch state). For example, the training data are sound recordings of individual speakers, that is to say a set of Nᵢ log spectra of i individual speakers, Sᵢ={sᵢ⁽¹⁾, . . . , sᵢ^{(N}^{ᵢ}⁾}, together with the respective pitch values {xᵢ⁽¹⁾, . . . , xᵢ^{(N}^{ᵢ}⁾}. These data can be generated automatically from individual speaker recordings using a pitch tracker.

The EM algorithm is an iterative optimisation method for estimating unknown parameters with the presence of known data, such as training data. The probability for the occurrence of a stochastic process with a predefined model is maximised iteratively by alternating classification (expectation step) and a subsequent adjustment of the model parameters (maximisation step).

Since the stochastic process (in the present case the spectrum of the speech signal) is given by the training data, the model parameters have to be adapted for maximisation. The precondition for the discovery of this maximum is that the likelihood of the model increases after each induction step and the calculation of a new model. To initialise the learning algorithm, a number of superposed Gaussian distributions and a GMM with any parameters (for example mean value, variance and weighting factor) are selected.

As a result of the iterative maximum likelihood (ML) estimation of the EM, a representative model for the individual speaker speech signal is thus obtained, in the present case a speaker-dependent GMM

$$p ( {s}_{i} \vert {Θ}_{i , {x}_{i}}^{{M}_{i , {x}_{i}}} ) .$$

For each speaker, 170 GMMs must therefore be trained, that is to say one GMM for each pitch state xᵢ, corresponding to the above-defined number of states.

In the present exemplary embodiment, the state-dependent individual log spectra of the speakers are thus modelled by means of GMM as follows

$$p ( {s}_{i} \vert {x}_{i} ) = p ( {s}_{i} \vert {Θ}_{i , {x}_{i}}^{{M}_{i} , {x}_{i}} ) = {\sum }_{m = 1}^{{M}_{i} , {x}_{i}} {α}_{i , {x}_{i}}^{m} NV ( {s}_{i} \vert {θ}_{i , {x}_{i}}^{m} ) , with i ∈ \{ 1 , 2 \} .$$

M_{i,x}_{ᵢ}≧1 denotes the number of mixture components (that is to say the normal distributions necessary to for representation of the spectrum), α_{i,x}_{ᵢ}^{m} is the weighting factor of each component m=1, . . . , M_{i,x}_{ᵢ}. “NV” denotes the normal distribution.

The weighting factor α_{i,x}_{ᵢ}^{m} has to be positive—α_{i,x}_{ᵢ}^{m}≧0—and meet the standardisation condition

$${\sum }_{m = 1}^{{M}_{i , {x}_{i}}} {α}_{i , {x}_{i}}^{m} = 1.$$

The respective GMM is determined completely by the parameter Θ_{i,x}_{ᵢ}^{M}^{ᵢ}^{,x}^{ᵢ}={α_{i,x}_{ᵢ}^{m}, θ_{i,x}_{ᵢ}^{m}}ₘ₌₁^{M}^{ᵢ}^{x}^{ᵢ} with θ_{i,x}_{ᵢ}^{m}={μ_{i,x}_{ᵢ}^{m}, Σ_{i,x}_{ᵢ}^{m}}; μrepresents the mean value, and Σ denotes the covariance.

After the training phase, GMMs for all fundamental frequency values of all speakers are thus provided. In the present exemplary embodiment, this means: Two speakers each with 170 states from the frequency interval 80 to 500 Hz. It should again be noted that this is an exemplary embodiment and that the method can also be applied to a number of signal sources and other frequency intervals.

### Interaction Model

The recorded single-channel speech signals sampled at a sampling frequency for example of fₛ=16kHz are considered over periods of time for analysis. In each period of time t, the observed (log) spectrum y^{(t)} of the mix signal, that is to say of the mixture of the two individual speaker signals, is modelled with the observation probability p(y^{(t)}|x₁^{(t)}, x₂^{(t)}. Based on this observation probability, the most probable pitch states at any moment of both speakers can be established for example, or the observation probability is used directly as an input for the tracking algorithm used in step c).

In principle, the (log) spectra of the individual speakers, or p(s₁|x₁) and p(s₂|x₂), can be added to the mix signal y; the magnitude spectra are added together approximately, and therefore the following is true for the log magnitude spectra: y≅log(exp(s₁)+exp(s₂)). The probability distribution of the mix signal is thus a function of the two individual signals, p(y)=f(p(s₁), p(s₂)). The function is then dependent on the interaction model selected.

A number of approaches are possible for this. With a linear model, the individual spectra in accordance with the above-mentioned form are added in the magnitude spectrogram, and the mix signal is thus approximately the sum of the magnitude spectra of the individual speakers. Expressed more simply, the sum of the probability distributions of the two individual speakers, NV(s₁|μ₁, Σ₁) and NV(s₂|μ₂Σ₂), thus forms the probability distribution of the mix signal NV(y|μ₁+μ₂, Σ₁+Σ₂), wherein, in this case, normal distributions are quoted merely for reasons of improved comprehension—in accordance with the method according to the invention, the probability distributions are GMMs.

In the illustrated exemplary embodiment of the method according to the invention, a further interaction model is used: The log spectrogram of two speakers can be approximated by the element-based maximum of the log spectra of the individual speakers in accordance with the mix-max interaction model. It is thus possible to quickly obtain a good probability model of the observed mix signal. The duration and processing effort of the learning phase are thus reduced drastically.

For each period of time t, y^{(t)}≅max(s₁^{(t)}, s₂^{(t)}), wherein sᵢ^{(t)} is the log magnitude spectrum of the speaker i. The log magnitude spectrum y^{(t)} is thus generated by means of a stochastic model, as illustrated in FIG. 1.

Therein, the two speakers (i=1, 2) each produce a log magnitude spectrum sᵢ^{(t)} in accordance with the fundamental frequency state xᵢ^{(t)}. The observed log magnitude spectrum y^{(t)} of the mix signal is approximated by the element-based maxima of both individual speaker log magnitude spectra. In other words: For each frame of the time signal (samples of the time signal are combined in frames, and the short-term magnitude spectrum is then calculated from samples within a frame by means of FTT (fast Fourier transformation) and with the exclusion of the phase information), the logarithmic magnitude spectrogram of the mix signal is approximated by the element-based maximum of both logarithmic individual speaker spectra. Instead of taking into account the inaccessible speech signals of the individual speakers, the probabilities of the spectra that were able to be learned individually beforehand are taken into account.

Speaker i generates a log spectrum sᵢ^{(t)} for a fixed fundamental frequency value with respect to a state xᵢ^{(t)}, said log spectrum representing realisation of the distribution described by the individual speaker model p(sᵢ^{(t)}|xᵢ^{(t)}).

The two log spectra are then combined by the element-based maximum operator so as to form the observable log spectrum y^{(t)}. This thus gives p(y^{(t)}|s₁^{(t)}, s₂^{(t)})=δ(y^{(t)}−max(s₁^{(t)}, s₂^{(t)})), wherein δ(.) denotes the Dirac delta function.

With use of the mix-max interaction model, the GMMs for each state of each speaker therefore have to be established, that is to say twice the cardinality of the state variables. In conventional models, a total of 28900 different fundamental frequency pairings result with the assumed 170 different fundamental frequency states for each speaker, which leads to a considerably increased processing effort.

In addition to the linear model and the mix-max interaction model, other models may also be used. An example for this is the Algonquin model, as described for example by Brendan J. Frey et al. in “ALGONQUIN—Learning dynamic noise models from noisy speech for robust speech recognition” (Advances in Neural Information Processing Systems 14, MIT Press, Cambridge, p. 1165-1172, January 2002).

As also with the mix-max interaction model, with the Algonquin model the log magnitude spectrum of the mixture of two speakers is modelled. Whilst, with the mix-max interaction model, y=max(s₁,s₂), the Algonquin model has the following form: y=s₁+log(1+exp(s₂−s₁).

From this, the probability distribution of the mix signal can in turn be derived from the probability distribution of the individual speaker signals.

As already mentioned, only the mix-max interaction model is concerned in the illustrated exemplary embodiment of the method according to the invention.

### Tracking

The object of tracking includes, in principle, the search for a sequence of hidden states x*, which maximises the resultant probability distribution x*=arg maxₓp(x|y). For tracking of the pitch curves over time, an FHMM is used in the described exemplary embodiment of the method according to the invention. The FHMM makes it possible to track the states of a number of Markov chains running in parallel over time, wherein the available observations are considered to be a common effect of all individual Markov chains. The results described under the heading “Interaction Model” are used.

In the case of an FHMM, a number of Markov chains are thus considered in parallel, as is the case for example in the described exemplary embodiment, where two speakers speak at the same time. The situation produced is illustrated in FIG. 2.

As mentioned above, the hidden state variables of the individual speakers are denoted by xₖ⁽¹⁾, wherein k denotes the Markov chains (and therefore the speakers) and the time index t runs from 1 to T. The Markov chains 1, 2 are illustrated running horizontally in FIG. 2. The assumption means that all hidden state variables have the cardinality |X|, that is to say 170 states in the described exemplary embodiment. The observed random variable is denoted by y^{(t)}.

The dependence of the hidden variables between two successive periods of time is defined by the transition probability p(xₖ^{(t)}|xₖ^{(t-1)}). The dependence of the observed random variables y^{(t)} on the hidden variables of the same period of time is defined by the observation probability p(y^{(t)}|x₁^{(t)}, x₂^{(t)}), which, as already mentioned further above, can be established by means of an interaction model. The output probability of the hidden variables in each chain is given as p(xₖ⁽¹⁾).

The entire sequence of the variables is x=∪ₜ₌₁^{T {x}₁^{(t}_, x₂^{(t)}} and y=∪ₜ₌₁^{T}{y^{(t)}}, and the following expression is given for the common distribution of all variables:

$$p ( x , y ) = p ( y \vert x ) p ( x ) = {\prod }_{k = 1}^{2} p ( {x}_{k}^{( 1 )} ) {\prod }_{t = 2}^{T} p ( {x}_{k}^{( t )} \vert {x}_{k}^{( t - 1 )} ) {\prod }_{t = 1}^{T} p ( {y}^{( t )} \vert {x}_{1}^{( t )} , {x}_{2}^{( t )} ) .$$

In the case of FHMM, each Markov chain gives a |X|×|X | transition matrix between two hidden states—in the case of HMM, a |X²|×|X²| transition matrix would be allowed, that is to say one which is disproportionately greater.

The observation probability p(y^{(t)}|x₁^{(t)}, x₂^{(t)}) is given generally by means of marginalisation over the unknown (log) spectra of the individual speakers:

p(y^{(t)}|x₁^{(t)}, x₂^{(t)})=∫∫p(y^{(t)}|s₁^{(t)}, s₂^{(t)})p(s₁^{(t)}|x₁^{(t)})p(s₂^{(t)}|x₂^{(t)})d s₁^{(t)}d s₂^{(t)} (1),

wherein p(y^{(t)}|s₁^{(t)}, s₂^{(t)}) represents the interaction model.

The following representation is thus given for (1) with use of speaker-specific GMMs, marginalisation over sᵢ and with use of the mix-max model:

$$p ( y \vert {x}_{1} , {x}_{2} ) = {\sum }_{m = 1}^{{M}_{1 , {x}_{1}}} {\sum }_{n = 1}^{{M}_{2 , {x}_{2}}} {α}_{1 , {x}_{1}}^{m} {α}_{2 , x 2}^{n} {\prod }_{d = 1}^{D} \{ NV ( {y}_{d} \vert {θ}_{1 , {x}_{1}}^{m , d} ) φ ( {y}_{d} \vert {θ}_{2 , {x}_{2}}^{n , d} ) + φ ( {y}_{d} \vert {θ}_{1 , {x}_{1}}^{m , d} ) NV ( {y}_{d} \vert {θ}_{2 , {x}_{2}}^{n , d} ) \} ,$$

wherein y_{d} gives the d-te element of the log spectrum y, θ_{i,x}_{ᵢ}^{m,d} gives the d-te element of the respective mean value and of the variance, and Ø(y|θ)=∫_{-∞}^{y}NV(x|θ)dx represents the univariant cumulative normal distribution.

Equally, the following representation is given for (1) with use of the linear interaction model:

$$p ( y \vert {x}_{1} , {x}_{2} ) = {\sum }_{m = 1}^{{M}_{1 , {x}_{1}}} {\sum }_{n = 1}^{{M}_{2 , {x}_{2}}} {α}_{1 , {x}_{1}}^{m} {α}_{2 , x 2}^{n} NV ( y \vert {μ}_{1 , {x}_{1}}^{m} + {μ}_{2 , {x}_{2}}^{n} , {\sum }_{1 , {x}_{1}}^{m} + {\sum }_{2 , {x}_{2}}^{n} ) ,$$

wherein y is the spectrum of the mix signal.

FIG. 3 shows a schematic illustration of the course of the method according to the invention on the basis of a block diagram.

A speech signal or a mixture of a number of individual signals is recorded over a single channel, for example using a microphone. This method step is denoted in the block diagram by 100.

In an independent method step, which is carried out for example before application of the method, the speech signals of the individual speakers are modelled in a training phase 101 with use of training data. With use of the EM (expectation maximisation) algorithm, a speaker-dependent GMM is trained for each of the 170 pitch states. The training phase is carried out for all possible states—in the described exemplary embodiment that is 170 states between 80 and 500 Hz for each of two speakers. In other words, a fundamental-frequency-dependent spectrogram of each speaker is thus trained by means of GMM, wherein the MDL criterion is applied so as to discover the optimal number of Gaussian components. In a further step 102, the GMMs, or the associated parameters, are stored, for example in a database.

103: To obtain a probabilistic reproduction of the mix signal of two or more speakers or of the individual signal portions of the mix signal, an interaction model is used, preferably the mix-max interaction model. The FHMM is then applied within the scope of the tracking 104 of the fundamental frequency curves. It is possible, by means of FHMM, to track the states of a number of hidden Markov processes that take place simultaneously, wherein the available observations are considered to be effects of the individual Markov processes.

1. A method for establishing fundamental frequency curves of a plurality of signal sources from a single-channel audio recording of a mix signal, said method comprising the following steps:
a) establishing the spectrogram properties of the pitch states of individual signal sources with use of training data;
b) establishing the probabilities of the possible fundamental frequency combinations of the signal sources contained in the mix signal by a combination of the properties established in a) by means of an interaction model; and
c) tracking the fundamental frequency curves of the individual signal sources.

2. The method according to claim 1, characterised in that the spectrogram properties are established in a) by means of a Gaussian mixture model (GMM).

3. The method according to claim 2, characterised in that the minimum-description-length criterion is also applied so as to establish the number of components of the GMM.

4. The method according to claim 1, characterised in that a linear model or the mix-max interaction model or the ALGONQUIN interaction model is used in b) as the interaction model.

5. The method according to claim 1, characterised in that the tracking in c) is carried out by means of the factorial hidden Markov model (FHMM).

6. (Original The method according to claim 5, characterised in that the sum-product algorithm or the max-sum algorithm is used to solve the FHMM.

7. The method according to claim 2, characterised in that a linear model or the mix-max interaction model or the ALGONQUIN interaction model is used in b) as the interaction model.

8. The method according to claim 3, characterised in that a linear model or the mix-max interaction model or the ALGONQUIN interaction model is used in b) as the interaction model.

9. The method according to claim 2, characterised in that the tracking in c) is carried out by means of the factorial hidden Markov model (FHMM).

10. The method according to claim 3, characterised in that the tracking in c) is carried out by means of the factorial hidden Markov model (FHMM).

11. The method according to claim 4, characterised in that the tracking in c) is carried out by means of the factorial hidden Markov model (FHMM).

12. The method according to claim 7, characterised in that the tracking in c) is carried out by means of the factorial hidden Markov model (FHMM).

13. The method according to claim 7, characterised in that the sum-product algorithm or the max-sum algorithm is used to solve the FHMM.

14. The method according to claim 8, characterised in that the sum-product algorithm or the max-sum algorithm is used to solve the FHMM.

15. The method according to claim 9, characterised in that the sum-product algorithm or the max-sum algorithm is used to solve the FHMM.

16. The method according to claim 10, characterised in that the sum-product algorithm or the max-sum algorithm is used to solve the FHMM.

17. The method according to claim 11, characterised in that the sum-product algorithm or the max-sum algorithm is used to solve the FHMM.

18. The method according to claim 12, characterised in that the sum-product algorithm or the max-sum algorithm is used to solve the FHMM.
